(19) United States
(12) Patent Application Publication
(10) Pub. No.: US 2017/0057293 A1
(43) Pub. Date: Mar. 2, 2017

(54) Crown Reinforcement For An Airplane Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-paccot (CH)

(72) Inventors: Vincent ESTENNE, Clermont-Ferrand Cedex 9 (FR); Emmanuel JOULIN, Clermont-Ferrand Cedex 9 (FR)

(21) Appl. No.: 15/304,662

(22) PCT Filed: Apr. 17, 2015
(86) PCT No.: PCT/EP2015/058345

§ 371 Date: Oct. 17, 2016

(30) Foreign Application Priority Data
Apr. 18, 2014 (FR) 1453527

(51) Int. Cl. B60C 9/26; B60C 9/18; B60C 9/00

(52) U.S. Cl. CPC B60C 9/263; B60C 9/0007; B60C 9/0042; B60C 9/1807; B60C 2200/02; B60C 2009/0021

(57) ABSTRACT

Working reinforcement (2) of airplane tire (1) is radially inside tread (3) and radially outside carcass reinforcement (4), comprising carcass layer (41). Working reinforcement (2) comprises working biply (21) of greatest axial width (L_{T}) and two axial ends (E). Hoop reinforcement (7) comprises hooping layer (71) radially inside working biply (21), and having axial width (L_{F}) at least equal to 0.8 times L_{T}. Distance D between axial end (E) of greatest axial width (L_{T}) and its orthogonal projection (I) onto the radially outermost carcass layer (41) is at least equal to 7 mm and the distance D′ between point (F) of working biply (21) of greatest axial width (L_{T}), axially inside axial end (E) at a distance L equal to 25 mm, and its orthogonal projection (J) onto the radially outermost carcass layer (41) is at least equal to 4 mm and at most equal to the distance D.

The present invention relates to an airplane tire and, in particular, to an airplane tire crown reinforcement.

In what follows, the circumferential, axial and radial directions respectively denote a direction tangential to the tread surface of the tire in the direction of rotation of the tire, a direction parallel to the axis of rotation of the tire and a direction perpendicular to the axis of rotation of the tire. “Radially on the inside or, respectively, radially on the outside” means “closer to or, respectively, further away from the axis of rotation of the tire”. “Axially on the inside or, respectively, axially on the outside” means “closer to or, respectively, further away from the equatorial plane of the tire”, the equatorial plane of the tire being the plane that passes through the middle of the tread surface of the tire and is perpendicular to the axis of rotation of the tire.

In general, a tire comprises a tread intended to come into contact with the ground via a tread surface, the tread being connected by two sidewalls to two beads, the two beads being intended to provide mechanical connections between the tire and a rim on which the tire is mounted.

A radial airplane tire more particularly comprises a radial carcass reinforcement and a crown reinforcement, as described, for example, in document EP 1381525.

The radial carcass reinforcement is the tire reinforcing structure that connects the two beads of the tire. The radial carcass reinforcement of an airplane tire generally comprises at least one carcass layer, each carcass layer being made up of reinforcers, usually textile, coated in a polymeric material of the elastomer or elastomer compound type, the reinforcers being mutually parallel and forming, with the circumferential direction, an angle of between 80° and 100°.

The crown reinforcement is the tire reinforcing structure radially on the inside of the tread and at least partially radially on the outside of the radial carcass reinforcement. The crown reinforcement of an airplane tire generally comprises at least one crown layer, each crown layer being made up of mutually parallel reinforcers coated in a polymeric material of the elastomer or elastomer compound type. Among the crown layers, a distinction is usually made between the working layers that constitute the working reinforcement, usually made up of textile reinforcers, and the protective layers that constitute the protective reinforcement, made up of metal or textile reinforcers and arranged radially on the outside of the working reinforcement. The working reinforcement dictates the overall mechanical behaviour of the crown reinforcement, while the protective reinforcement essentially protects the working layers from attack likely to spread through the tread radially towards the inside of the tire.

Furthermore, the crown reinforcement of an airplane tire may comprise a hoop reinforcement comprising at least one hooping layer comprising reinforcers, usually textile reinforcers, coated in an elastomeric material and which are substantially circumferential, which means to say which form, with the circumferential direction of the tire, an angle at most equal to 5°. The hoop reinforcement is a reinforcement that is generally centred on the equatorial plane of the tire. A hooping layer may adopt different positions in the radial direction: it may be radially on the inside of the working reinforcement, which means to say of any working layer, or radially on the outside of the working reinforcement, which means to say of any working layer, or interposed radially between two consecutive working layers. A hoop reinforcement as previously described guarantees high circumferential rigidity in the equatorial portion of the tire and, therefore, good control over the radial deformations of the tire caused by centrifuging.

The textile reinforcers of the carcass layers and of the crown layers are usually cords made up of spun textile filaments, preferably made of aliphatic polyamide or of aromatic polyamide. The mechanical properties under tension, such as the elastic modulus, the elongation at break and the force at break, of the textile reinforcers are measured after prior conditioning. “Prior conditioning” means the storage of the textile reinforcers for at least 24 hours, prior to measurement, in a standard atmosphere in accordance with European Standard DIN EN 20139 (temperature of 20±2° C.; relative humidity of 65±2%). The measurements are taken in the known way using a ZWICK GmbH & Co (Germany) tensile test machine of type 1435 or type 1445. The textile reinforcers are subjected to tension over an initial length of 400 mm at a nominal rate of 200 mm/min All the results are averaged over 10 measurements.

During the manufacture of an airplane tire and, more specifically, during the step of laying the working reinforcement, a working layer is usually obtained by zigzag circumferential winding of a strip on a cylindrical laying surface having as its axis of revolution the axis of rotation of the tire. The working layer is then made up of the juxtaposition of contiguous portions of strip.

What is meant by zigzag circumferential winding of a strip is winding of the strip, in the circumferential direction, along a periodic curve, which means to say a curve made up of periodic undulations oscillating between extrema. Winding a strip with a periodic curve means that the midline of the strip, equidistant from the edges of the strip, coincides with the periodic curve. In the case of a zigzag circumferential winding, the midline of the strip forms, with the circumferential direction of the tire and in the equatorial plane of the tire, an angle at least equal to 8° and at most equal to 30°. In other words, the reinforcers that make up each working layer form, with the circumferential direction of the tire and in the equatorial plane of the tire, an angle at least equal to 8° and at most equal to 30°. Such a working reinforcement comprising working biplies obtained by circumferential zigzag winding of a strip has been described in documents EP 0240303, EP 0850787, EP 1163120 and EP 1518666.

During circumferential zigzag winding of a strip, the working layers are laid in pairs, each pair of working layers constituting a working biply. Thus, a working biply is made up, in its main section, which means to say away from the axial ends thereof, of two radially superposed working layers. At its axial ends, a working biply generally comprises more than two radially superposed working layers. The number of additional working layers, in the radial direction, compared with the two working layers of the main section of the working biply are referred to as the axial end overthickness. This axial end overthickness is generated by the crossings of the strip, at the end of the working biply, for each turn of zigzag winding.

Regarding the laying of the hoop reinforcement, a hooping layer is usually obtained by a circumferential winding in turns of a strip on a cylindrical laying surface having as its axis of revolution the axis of rotation of the tire. The hooping layer is therefore made up of the juxtaposition of contiguous portions of strip.

What is meant by circumferential winding in turns of a strip is a winding of the strip, in the circumferential direction, and in a helix of radius equal to the radius of the cylindrical laying surface and at a mean angle, with respect to the circumferential direction, comprised between 0° and 5°. The hooping layer thus obtained by winding in turns is said to be circumferential because the angle of the textile reinforcers, pairs of which are mutually parallel, of the strip, formed in the equatorial plane and with the circumferential direction, is comprised between 0° and 5°.

The strip that makes up a working layer or a hooping layer is generally made up of at least one continuous textile reinforcer coated in an elastomeric compound and, most usually, of a juxtaposition of mutually parallel continuous textile reinforcers coated in an elastomeric compound.

The advantage of having zigzag circumferential winding, in the case of a working layer, or circumferential winding in turns, in the case of a hooping layer, is that, at the axial ends of the said working or hooping layers, it avoids there being free ends of reinforcers liable to generate cracks in these zones and therefore to reduce the endurance of the crown reinforcement and the life of the tire.

Regarding the working reinforcement, it is nevertheless known that the axial end overthicknesses of the working biplies and, in particular, those of the working biply of greatest axial width, are sensitive to the onset of endurance damage, such as cracks that may evolve into significant degradation of the working reinforcement and, in some instances, lead to a reduction in the life of the tire.

This is because in the axial end overthicknesses and the vicinity thereof, the thermomechanical stresses are very high, when the tire is compressed and driven on, in the conditions of service of an airplane. For example, and nonlimitingly, a commercial airline airplane tire may be subjected to a nominal pressure in excess of 15 bar, a nominal load in excess of 20 tonnes and a maximum speed of 360 km/h. This results in a significant dissipation of heat and therefore a high temperature level likely to limit the endurance performance of the tire.

The endurance performance of an airplane tire is generally measured on an elementary qualification test such as the TSO (Technical Standard Order) test imposed by an FAA (Federal Aviation Administration) standard.

The TSO test is a test performed in rolling mode and that is broken down into 4 phases:
50 airplane takeoff cycles, in which the tire is subjected to the nominal pressure Pᵥ and to a load that varies between the nominal load Zₙ and 0.
8 airplane taxiing cycles, in which the tire is subjected to the nominal pressure Pᵥ, to the nominal load Zₙ and to a speed of around 65 km/h for about 10 700 m.
2 airplane taxiing cycles, in which the tire is subjected to the nominal pressure Pᵥ, to 1.2 times the nominal load Zₙ and to a speed of around 65 km/h for about 10 700 m.
1 overloaded airplane takeoff cycle, in which the tire is subjected to the nominal pressure Pᵥ and to a load that varies between 1.5 times the nominal load Zₙ and 0.

The objective of the TSO test is to perform all the cycles without any damage to the tire, although delamination of the tire, which means to say loss of the tread, is permitted during the final cycle, but not a loss in pressure.

There are solutions known to those skilled in the art for reducing the temperature at the axial ends of the working reinforcement, each of these solutions potentially having disadvantages:
use of a low-hysteresis elastomeric compound for the tread, this type of compound usually being sensitive to abrasion and therefore liable to accelerate tread wear;
use of a low-hysteresis elastomeric compound for a first intermediate component, axially on the inside of the tread and axially on the outside of the protective reinforcement, but with a risk of decohesion between said first intermediate component and the tread under harsh operating conditions, particularly during the TSO test;
optimization of the geometric profile of a second intermediate component, axially on the inside of the protective reinforcement and axially on the outside of the working reinforcement, but which can give rise to premature appearance of said second intermediate component at the surface of the tread, as the tread wears, hence leading to a risk of accelerated tread wear;
use of circumferential reinforcers for the working layers, which means to say of reinforcers forming a zero angle with the circumferential direction, something which may lead to a drop in the cornering stiffness of the tire and impaired control of its centrifuged inflated profile.

The inventors have set themselves the task of improving the endurance of the working reinforcement of an airplane tire by reducing the thermomechanical stresses at the axial end overthicknesses of the working biplies of which the working reinforcement is made.

This objective has been achieved, according to the invention, by an airplane tire comprising:
a working reinforcement radially on the inside of a tread and radially on the outside of a carcass reinforcement,
the working reinforcement comprising at least one working biply consisting at least in part of two radially superposed working layers,
each working layer comprising reinforcers coated in an elastomeric material, positioned circumferentially along a periodic curve and forming, with the circumferential direction of the tire and in the equatorial plane of the tire, an angle at least equal to 8° and at most equal to 30°,
the working biply of greatest axial width comprising two axial ends each one corresponding to the axially outermost and radially innermost point of the working biply,
the carcass reinforcement comprising at least one carcass layer comprising reinforcers which are coated in an elastomeric material, forming, with the circumferential direction of the tire, an angle at least equal to 80° and at most equal to 100°,
a hoop reinforcement comprising at least one hooping layer comprising reinforcers which are coated in an elastomeric material, forming, with the circumferential direction of the tire, an angle at most equal to 5°,
at least one hooping layer being radially on the inside of the working biply of greatest axial width, and having an axial width at least equal to 0.8 times the axial width of the working biply of greatest axial width,
the distance D between an axial end of the working biply of greatest axial width and its orthogonal projection onto the radially outermost carcass layer being at least equal to 7 mm and the distance D′ between the point of the working biply of greatest axial width, axially on the inside of the axial end at a distance L equal to 25 mm, and its orthogonal projection onto the radially outermost carcass layer being at least equal to 4 mm and at most equal to the distance D.

According to the invention, the axial end of the working biply of greatest axial width, which means to say the axially outermost point of the said working biply and the point of the said working biply positioned axially on the inside of the said axial end at a distance L equal to 25 mm, are positioned radially on the outside of the radially outermost carcass layer at respective distances D and D′ at least equal to minimal values. The distance D between the axial end of the working biply of greatest axial width and its orthogonal projection onto the radially outermost carcass layer is at least equal to 7 mm The distance D′ between the point of the working biply of greatest axial width, axially on the inside of the axial end at a distance L equal to 25 mm, and its orthogonal projection onto the radially outermost carcass layer is, on the one hand, at least equal to 4 mm and, on the other hand, at most equal to the distance D.

These minimum distances, which are greater than those usually found on a tire of the prior art, make it possible to obtain a geometric profile for the end of the working biply of greatest axial width that is further from the carcass reinforcement than is the case in a tire of the prior art. This geometric profile, said to be recorded at the axial end, makes it possible to reduce the cyclic thermomechanical stresses at the axial end of the working biply and, therefore, the temperature in this zone, thus making it possible to improve the endurance of the working reinforcement and increase the life of the tire.

The distance D between an axial end of the working biply of greatest axial width and its orthogonal projection onto the radially outermost carcass layer is advantageously at most equal to 16 mm. This maximum value reduces the risk of the axial end of the working biply appearing at the surface of the tire if the axial end portion or shoulder of the tread wears away.

The reinforcers of the working layers of any working biply are preferably made of a textile material. The textile guarantees a good compromise between the mass and the breaking strength of the reinforcers. The use of textile reinforcers for any working biply, which means to say for all the working layers, makes a significant contribution to minimizing the mass of the tire and therefore to increasing the payload of the airplane. Among the textile reinforcers commonly used in airplane tires a distinction is made between reinforcers made of an aliphatic polyamide, such as nylon, and reinforcers made of an aromatic polyamide such as aramid. Reinforcers made of aromatic polyamide offer a better compromise between mass and breaking strength than do reinforcers made of aliphatic polyamide.

According to one preferred embodiment, the reinforcers of the working layers of at least the working biply of greatest axial width are advantageously hybrid reinforcers made up of a combination of an aliphatic polyamide and an aromatic polyamide. The working biply of greatest axial width has the most heavily mechanically loaded axial ends, hence the benefit in using, for the working layers of this working biply, hybrid reinforcers which offer both the advantages of an aliphatic polyamide and those of an aromatic polyamide: high breaking strength, high tensile deformability and low mass.

The reinforcers of the hooping layers are advantageously reinforcers containing an aromatic polyamide. They are even often made of a single aromatic polyamide such as an aramid. Reinforcers made of aromatic polyamide offer a good compromise between low mass and high breaking strength.

The tire usually comprises a protective reinforcement comprising at least one protective layer radially on the outside of the working reinforcement and the purpose of which is to protect the working reinforcement against mechanical attack of the tread.

At least one protective layer preferably comprises metal reinforcers coated in an elastomeric material. The benefit of having metal reinforcers rather than textile reinforcers as in the working or hooping layers is that of guaranteeing effective protection of the working reinforcement against FOD (Foreign Object Damage). These reinforcers are generally wavy in the circumferential direction.

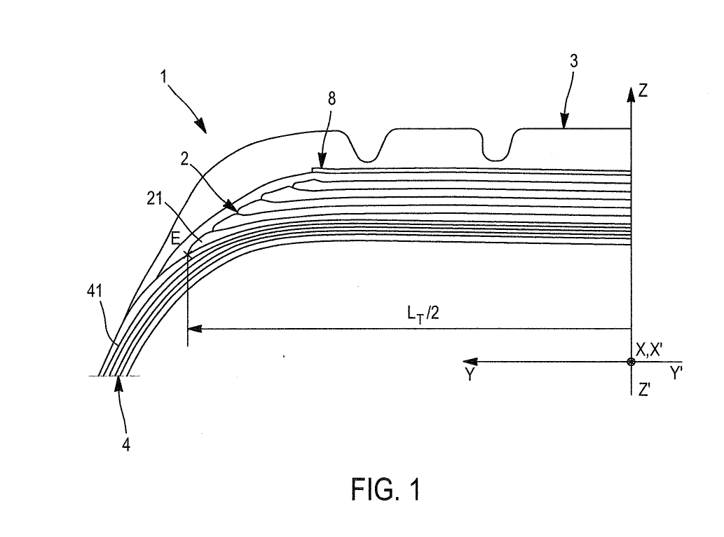

The features and other advantages of the invention will be better understood with the aid of the following FIGS. 1 to 5 which are not drawn to scale:

FIG. 1: A half-view in cross section of the crown of an airplane tire of the prior art, the section being in a radial plane (YZ) passing through the axis of rotation (YY′) of the tire.

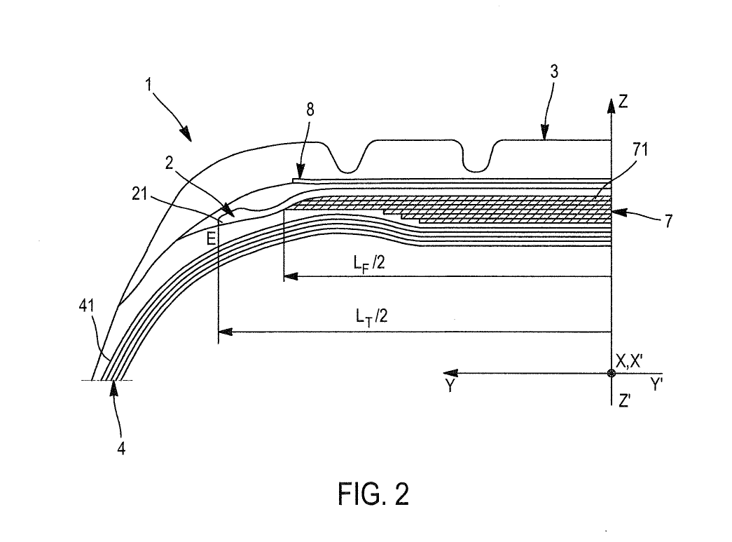

FIG. 2: A half-view in cross section of the crown of an airplane tire according to the invention, the section being in a radial plane (YZ) passing through the axis of rotation (YY′) of the tire.

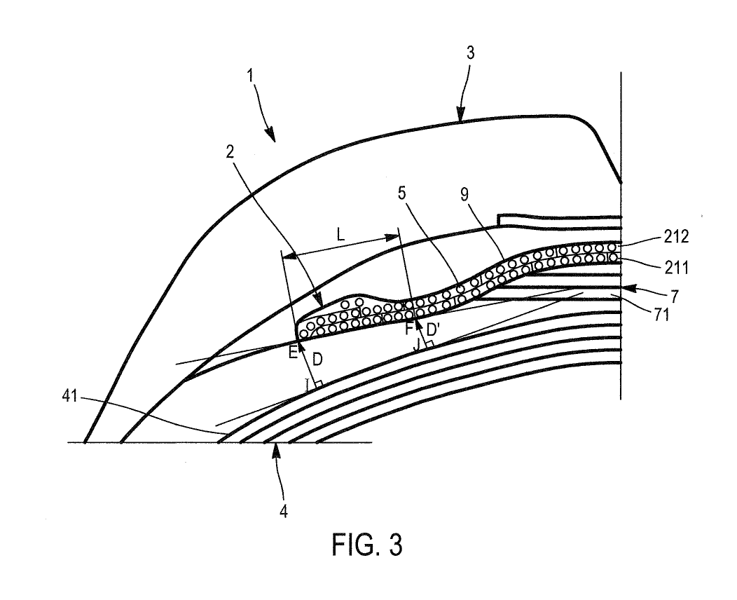

FIG. 3: A detailed view in cross section of the axial end of the working reinforcement of an airplane tire according to the invention, the section being in a radial plane (YZ) passing through the axis of rotation (YY′) of the tire.

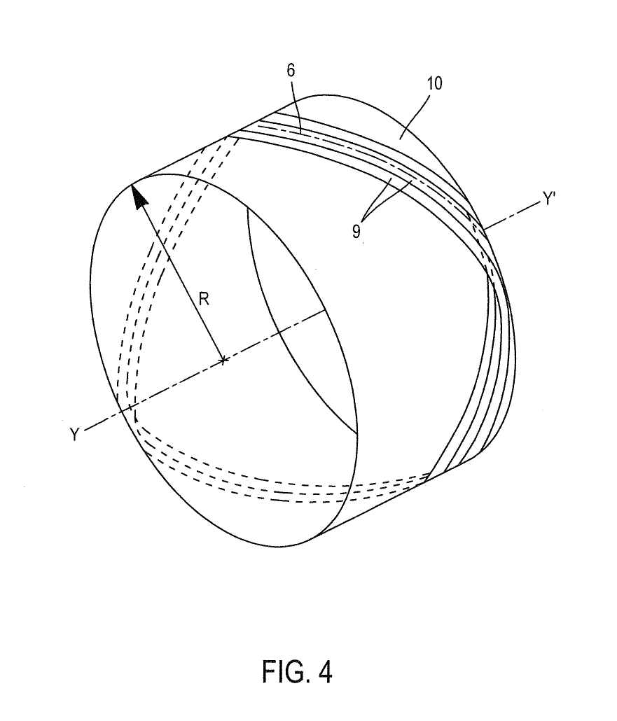

FIG. 4: A perspective view of a strip that makes up a working biply of an airplane tire, circumferentially wound in a zigzag along a periodic curve on a cylindrical laying surface.

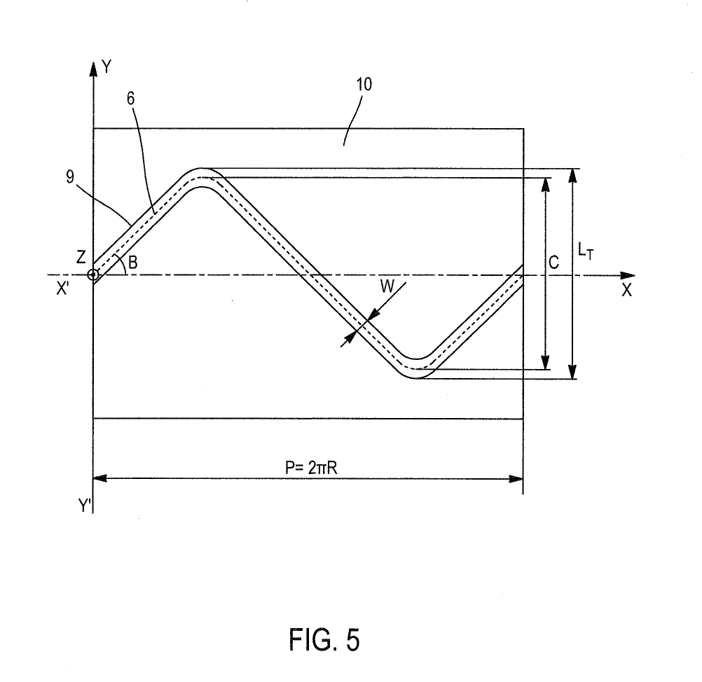

FIG. 5: A developed view of a strip that makes up a working biply of an airplane tire, wound circumferentially in a zigzag along a periodic curve after one period has been laid.

FIG. 1 depicts, in a radial plane YZ passing through the axis of rotation YY′ of the tire, a half-view in cross section of the crown of an airplane tire 1 of the prior art, comprising a working reinforcement 2 radially on the inside of a tread 3 and radially on the outside of a carcass reinforcement 4. In the example given, the working reinforcement 2 comprises five working biplies 21, the radially innermost working biply having the greatest axial width L_{T}, measured between its two axial ends. FIG. 1 shows only a half-width L_{T}/2 between an axial end E of the radially innermost working biply 21 and the equatorial plane XZ. Each working biply 21 is made up at least in part of two radially superposed working layers (211, 212) (see FIG. 3). Each working layer (211, 212) comprises textile reinforcers of the aliphatic polyamide type, coated in an elastomeric material. The carcass reinforcement 4 comprises a radial superposition of carcass layers 41. Each carcass layer 41 comprises textile reinforcers of the aliphatic polyamide type, coated in an elastomeric material and forming, with the circumferential direction XX′ of the tire, an angle at least equal to 80° and at most equal to 100°. Furthermore, radially on the inside of the tread 3, the tire 1 comprises a protective reinforcement 8 made up of a protective layer.

FIG. 2 shows, in a radial plane YZ passing through the axis of rotation YY′ of the tire, a half-view in cross section of the crown of an airplane tire 1 according to the invention, comprising a working reinforcement 2 radially on the inside of a tread 3 and radially on the outside of a carcass reinforcement 4. In the example given, the working reinforcement 2 comprises one single working biply 21, the working biply having, of all the crown layers, the greatest axial width L_{T}, measured between its two axial ends E. FIG. 2 shows only a half-width L_{T}/2 between an axial end E of the working biply 21 and the equatorial plane XZ. The working biply 21 is made up at least in part of two radially superposed working layers (211, 212) (see FIG. 3). Each working layer (211, 212) comprises reinforcers 5, generally hybrid reinforcers, made up of a combination of an aliphatic polyamide and of an aromatic polyamide, coated in an elastomeric material, positioned circumferentially along a periodic curve and forming, with the circumferential direction XX′ of the tire and in the equatorial plane XZ of the tire, an angle at least equal to 8° and at most equal to 30°. Furthermore, radially on the inside of the working biply 21 of greatest axial width L_{T}, the tire 1 comprises a hoop reinforcement 7, comprising 6 hooping layers 71. Each hooping layer 71 comprises reinforcers, generally made of aromatic polyamide, coated in an elastomeric material and forming, with the circumferential direction XX′ of the tire, an angle at most equal to 5°. The axially widest hooping layer 71 is radially on the inside of and adjacent to the working biply 21, and has an axial width L_{F} at least equal to 0.8 times the axial width L_{T} of the said working biply 21. FIG. 2 depicts only an axial half-width L_{F}/2 of the axially widest hooping layer. The carcass reinforcement 4 comprises a radial superposition of carcass layers 41. Each carcass layer 41 comprises reinforcers, generally hybrid reinforcers, made up of a combination of an aliphatic polyamide and of an aromatic polyamide and forming, with the circumferential direction XX′ of the tire, an angle at least equal to 80° and at most equal to 100°. According to the invention, the geometric profile of the working biply 21 of greatest axial width L_{T}, at its axial end, is not pressed as firmly against the carcass reinforcement as is the case in the tire of the prior art depicted in FIG. 1.

FIG. 3 is a detailed view in cross section of the axial end of the working reinforcement 2 of an airplane tire 1 according to the invention, in a radial plane YZ passing through the axis of rotation YY′ of the tire. In the example given, the working reinforcement 2 comprises a working biply 21, the respective axial ends of which have overthicknesses. The working biply 21 is made up of two radially superposed working layers (211, 212) in the main section and of three working layers in the axial end zone. Each working layer (211, 212) is made up of the axial juxtaposition of strips 9, each strip itself being an axial juxtaposition of textile reinforcers 5 coated in an elastomeric compound. In this instance, the textile reinforcers 5 are hybrid reinforcers made up of a combination of an aliphatic polyamide and of an aromatic polyamide. The axially widest hooping layer 71 is radially on the inside of and adjacent to the working biply 21 of greatest axial width L_{T}, and has an axial width L_{F} at least equal to 0.8 times the axial width L_{T} of the working biply 21 of greatest axial width L_{T}. The carcass reinforcement 4 comprises a radial superposition of carcass layers 41, each carcass layer 41 comprising hybrid reinforcers made up of a combination of an aliphatic polyamide and of an aromatic polyamide and forming, with the circumferential direction XX′ of the tire, an angle at least equal to 80° and at most equal to 100°. According to the invention, the distance D between the axial end E of the working biply 21 of greatest axial width L_{T} and its orthogonal projection I onto the radially outermost carcass layer 41 is at least equal to 7 mm and the distance D′ between the point F of the working biply 21 of greatest axial width L_{T}, axially on the inside of the axial end E at a distance L equal to 25 mm, and its orthogonal projection J onto the radially outermost carcass layer 41 is at least equal to 4 mm and at most equal to the distance D.

FIG. 4 is a perspective view of a strip 9 that makes up a working biply of an airplane tire, circumferentially wound in a zigzag, along a periodic curve 6, onto a cylindrical laying surface 10 exhibiting symmetry of revolution about the axis of rotation (YY′) of the tire, having a radius R.

FIG. 5 is a developed view of a strip 9 that makes up a working biply of a tire according to the invention, circumferentially wound in a zigzag, along a periodic curve 6, after one period has been laid. The strip 9 is laid on a cylindrical surface 10 of circumference 2πR, depicted in developed form. The midline of the strip 9 follows a periodic curve 6, forming an angle B with the circumferential direction XX′. The periodic curve 6 has a period P equal to 2πR and an amplitude C which, increased by the width W of the strip 9, defines the width L_{T}=C+W of the working biply.

The inventors carried out the invention for an airplane tire of size 46X17 R 20 comprising, radially from the outside inwards, a protective reinforcement made up of a protective layer the reinforcers of which are made of metal, a working reinforcement made up of a working biply the reinforcers of which are hybrid, and a hoop reinforcement made up of six radially superposed hooping layers the reinforcements of which are made of aramid. The inventors compared a reference tire and a tire according to the invention, differing only in terms of the geometric profile of the working biply of greatest axial width, at its axial end, the said profile being said to have been measured for the tire according to the invention.

The geometric characteristics of the tires under investigation are given in Table 1 below:

TABLE 1

| | Reference | Invention | Difference |
|---|---|---|---|
| Distance D (mm) | 3 mm | 7 mm | 4 mm |
| Distance D′ (mm) | 2.5 mm | 4.5 mm | 2 mm |
| Distance L (mm) | 25 mm | 25 mm | |

The distances D, D′ and L are measured on a radial cross section of the tire.

The distance D is measured, at right angles to the radially outermost carcass layer, between the radially innermost point of the penultimate reinforcer of the working biply of greatest axial width and the radially outermost point of the first reinforcer encountered in the radially outermost carcass layer.

The distance D′ is measured, perpendicular to the radially outermost carcass layer, between the radially innermost point of the reinforcer of the working biply of greatest axial width, axially on the inside of the axially outermost reinforcer of the working biply of greatest axial width at a distance of 25 mm, and the radially outermost point of the first reinforcer encountered in the radially outermost carcass layer.

The distance L is measured as being the radius equal to 25 mm of the circle centred on the axially outermost reinforcer of the working biply of greatest axial width.

The respective performance of the tires of the prior art, considered by way of reference, and according to the invention were measured against three criteria: the temperature in the vicinity of the axial end of the working biply of greatest axial width, the maximal tensile load in the reinforcers at the axial end of the working biply of greatest axial width over one wheel revolution, and the maximum number of cycles achieved without damage during a TSO test. The first two criteria came from a finite element numerical simulation on the assumption of steady-state running of the tire at a speed of 10 km/h. The number of cycles without damage was determined by TSO tests.

The performance criteria for the tires studied are given in Table 2 below:

TABLE 2

| | Reference | Invention | Difference |
|---|---|---|---|
| Temperature at the axial end | 85° C. | 78° C. | 7° C. |
| under steady-state running at | | | |
| 10 km/h (° C.) | | | |
| Maximum tensile load at the axial | 16 daN | 12 daN | 4 daN |
| end, over one wheel revolution, in | | | |
| steady-state running at 10 km/h | | | |
| (daN) | | | |
| Number of cycles in TSO test | Base 100 | 161 | 61 |

This invention is applicable not only to an airplane tire but also to any tire comprising a crown reinforcement with at least one biply obtained by a zigzag winding of a strip such as, for example and nonexhaustively, a tire for a metro train.

1. An airplane tire comprising:
a working reinforcement radially on the inside of a tread and radially on the outside of a carcass reinforcement;
the working reinforcement comprising at least one working biply consisting at least in part of two radially superposed working layers;
each working layer comprising reinforcers coated in an elastomeric material, positioned circumferentially along a periodic curve and forming, with the circumferential direction of the tire and in the equatorial plane of the tire (XZ), an angle at least equal to 8° and at most equal to 30°;
the working biply of greatest axial width (L_{T}) comprising two axial ends (E) each one corresponding to the axially outermost and radially innermost point of the working biply;
the carcass reinforcement comprising at least one carcass layer comprising reinforcers which are coated in an elastomeric material, forming, with the circumferential direction of the tire, an angle at least equal to 80° and at most equal to 100°;
a hoop reinforcement comprising at least one hooping layer comprising reinforcers which are coated in an elastomeric material, forming, with the circumferential direction of the tire, an angle at most equal to 5°;
at least one hooping layer being radially on the inside of the working biply of greatest axial width (L_{T}), and having an axial width (L_{F}) at least equal to 0.8 times the axial width (L_{T}) of the working biply of greatest axial width (L_{T});
wherein the distance D between an axial end of the working biply of greatest axial width (L_{T}) and its orthogonal projection (I) onto the radially outermost carcass layer is at least equal to 7 mm and wherein the distance D′ between the point of the working biply of greatest axial width (L_{T}), axially on the inside of the axial end at a distance L equal to 25 mm, and its orthogonal projection (J) onto the radially outermost carcass layer is at least equal to 4 mm and at most equal to the distance D.

2. The airplane tire according to claim 1, wherein the distance D between an axial end of the working biply of greatest axial width (L_{T}) and its orthogonal projection onto the radially outermost carcass layer is at most equal to 16 mm.

3. The airplane tire according to claim 1, wherein the reinforcers of the working layers of any working biply are made of a textile material.

4. The airplane tire according to claim 1, wherein the reinforcers of the working layers of at least the working biply of greatest axial width (L_{T}) are hybrid reinforcers made up of a combination of an aliphatic polyamide and an aromatic polyamide.

5. The airplane tire according to claim 1, wherein the reinforcers of the hooping layers are reinforcers containing an aromatic polyamide.

6. The airplane tire according to claim 1, wherein the tire comprises a protective reinforcement comprising at least one protective layer.

7. The airplane tire according to claim 6, wherein at least one protective layer comprises metal reinforcers coated in an elastomeric material.
